(19) United States
(12) Patent Application Publication
(10) Pub. No.: US 2026/0084684 A1
(43) Pub. Date: Mar. 26, 2026

(54) RATIO CONTROL OF VEHICLE OUTPUT TORQUE VERSUS ENGINE ACCELERATION IN POWER CONSTRAINED SCENARIOS

(71) Applicant: FCA US LLC, Auburn Hills, MI (US)

(72) Inventors: Nadirsh Patel, Auburn Hills, MI (US); Abdulquadri Oluwatobi, Auburn Hills, MI (US); Shishir Khanal, Auburn Hills, MI (US); Hangxing Sha, Auburn Hills, MI (US); Krishna Madireddy, Auburn Hills, MI (US)

(21) Appl. No.: 18/893,217

(22) Filed: Sep. 23, 2024

(51) Int. Cl. B60W 20/15; B60W 10/08

(52) U.S. Cl. CPC B60W 20/15; B60W 10/08; B60W 2710/083

(57) ABSTRACT

A control method for power-split hybrid electric powertrain of an electrified vehicle includes determining an output torque request for the powertrain and a previous actual output torque and maximum output torque of the powertrain, performing proportional ratio control based on the output torque request, the actual output torque, and the maximum output torque of the powertrain to determine a desired engine acceleration ratio, applying a history filter to the desired engine acceleration ratio to obtain a target engine acceleration ratio, evaluating a set of conditions and selectively arbitrating between the target engine acceleration ratio and a maximum engine acceleration ratio based on the evaluation to determine a desired engine speed profile and an engine acceleration command, and determining motor torque commands based on the desired engine speed profile and the engine acceleration command.

### FIELD

The present application generally relates to electrified vehicles having internal combustion engines and, more particularly, to techniques for ratio control of vehicle output torque versus engine acceleration in power constrained scenarios.

### BACKGROUND

Some electrified powertrains have a degree of freedom between engine speed and vehicle speed (i.e., a non-linear relationship between vehicle output torque and engine acceleration). One example of such an electrified powertrain is a power-split hybrid configuration that includes an engine, two electric motors, and a planetary gear set. In such electrified powertrains, the system cannot fully or completely produce vehicle output torque and engine acceleration in-phase due to the balancing of the electrified powertrain. This is particularly true at very high output power demand, as well as when the system is electrically discharge constrained, and the system could lose control of engine actuator acceleration in favor of delivering output power demand. This negatively impacts vehicle drivability and could cause unintended vehicle deceleration. Accordingly, while such conventional electrified powertrain control systems do work for their intended purpose, an opportunity exists for improvement in the relevant art.

### SUMMARY

According to one example aspect of the invention, a control system for power-split hybrid electric powertrain of an electrified vehicle is presented. In one exemplary implementation, the control system comprises a set of actuators configured to control an engine of the powertrain and first and second electric motors of the powertrain, wherein the engine and the first and second electric motors are all connected to a planetary gear set and a control system configured to determine an output torque request for the powertrain and a previous actual output torque and maximum output torque of the powertrain, perform proportional ratio control based on the output torque request, the actual output torque, and the maximum output torque of the powertrain to determine a desired engine acceleration ratio, apply a history filter to the desired engine acceleration ratio to obtain a target engine acceleration ratio, evaluate a set of conditions and selectively arbitrate between the target engine acceleration ratio and a maximum engine acceleration ratio based on the evaluation to determine a desired engine speed profile and an engine acceleration command, determine motor torque commands based on the desired engine speed profile and the engine acceleration command, and control the first and second electric motors based on the motor torque commands and the engine based on the engine acceleration command.

In some implementations, the engine is connected to a carrier of the planetary gear set, the first electric motor is connected to a sun gear of the planetary gear set, and the second electric motor is connected to a drive pinion of the planetary gear set, and a ring gear of the planetary gear set and a counter-driven gear are connected to deliver output power of the powertrain. In some implementations, the set of evaluations comprises a first evaluation that evaluates if the first electric motor is available for speed control by comparing the first electric motor's torque at the current maximum acceleration limit against raw actuator limits. In some implementations, the set of evaluations comprises a second evaluation that evaluates based on a transmission state or position, that output power is not compromised against a sign change.

In some implementations, the set of evaluations comprises a third evaluation that evaluates hardware element limits of the powertrain to verify that, if the current engine acceleration limit was violated, hardware elements of the powertrain would not be damaged. In some implementations, the hardware element limits include a calculated clutch torque needed at a maximum engine acceleration against raw clutch capacities. In some implementations, the control system is configured to increase the maximum engine acceleration limit when all three evaluations are true or satisfied. In some implementations, the history filter is a recursive root-mean-square (RMS) moving average filter.

According to another example aspect of the invention, a control method for power-split hybrid electric powertrain of an electrified vehicle is presented. In one exemplary implementation, the control method comprises controlling, by a set of actuators, an engine of the powertrain and first and second electric motors of the powertrain, wherein the engine and the first and second electric motors are all connected to a planetary gear set, determining, by a control system, an output torque request for the powertrain and a previous actual output torque and maximum output torque of the powertrain, performing, by the control system, proportional ratio control based on the output torque request, the actual output torque, and the maximum output torque of the powertrain to determine a desired engine acceleration ratio, applying, by the control system, a history filter to the desired engine acceleration ratio to obtain a target engine acceleration ratio, evaluating, by the control system, a set of conditions and selectively arbitrating, by the control system, between the target engine acceleration ratio and a maximum engine acceleration ratio based on the evaluation to determine a desired engine speed profile and an engine acceleration command, determining, by the control system, motor torque commands based on the desired engine speed profile and the engine acceleration command, and controlling, by the control system, the first and second electric motors based on the motor torque commands and the engine based on the engine acceleration command.

In some implementations, the engine is connected to a carrier of the planetary gear set, the first electric motor is connected to a sun gear of the planetary gear set, and the second electric motor is connected to a drive pinion of the planetary gear set, and a ring gear of the planetary gear set and a counter-driven gear are connected to deliver output power of the powertrain. In some implementations, the set of evaluations comprises a first evaluation that evaluates if the first electric motor is available for speed control by comparing the first electric motor's torque at the current maximum acceleration limit against raw actuator limits. In some implementations, the set of evaluations comprises a second evaluation that evaluates based on a transmission state or position, that output power is not compromised against a sign change.

In some implementations, the set of evaluations comprises a third evaluation that evaluates hardware element limits of the powertrain to verify that, if the current engine acceleration limit was violated, hardware elements of the powertrain would not be damaged. In some implementations, the hardware element limits include a calculated clutch torque needed at a maximum engine acceleration against raw clutch capacities. In some implementations, the control system is configured to increase the maximum engine acceleration limit when all three evaluations are true or satisfied. In some implementations, the history filter is a recursive RMS moving average filter.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram depicting an electrified vehicle having an example power-split hybrid electric powertrain according to the principles of the present application;

FIGS. 2A-2B are lever system diagrams depicting an example power-split hybrid electric powertrain during hybrid and electric driving modes according to the principles of the present application;

FIGS. 3A-3C are functional block diagram of example system architectures for a control system for a power-split hybrid electric powertrain according to the principles of the present application;

FIG. 4 is a plot depicting an example ratio control process for engine acceleration versus vehicle output torque according to the principles of the present application; and

FIG. 5 is a flow diagram of an example ratio control method for an electrified vehicle having a power-split hybrid electric powertrain according to the principles of the present application.

### DESCRIPTION

As previously discussed, some electrified powertrains have a degree of freedom between engine speed and vehicle speed (i.e., a non-linear relationship between vehicle output torque and engine acceleration). One example of such an electrified powertrain is a power-split hybrid configuration that includes an engine, two electric motors, and a planetary gear set. In such electrified powertrains, the system cannot fully or completely produce vehicle output torque and engine acceleration in-phase due to the balancing of the electrified powertrain. This is particularly true at very high output power demand, as well as when the system is electrically discharge constrained. Conventional solutions selectively chose to either sacrifice engine acceleration for vehicle output torque delivery or vice-versa. This negatively impacts vehicle drivability (e.g., a loss of engine acceleration control or noticeable noise/vibration/harshness, or NVH) and could also cause unintended vehicle deceleration. Thus, an opportunity exists for improvement in the art.

Accordingly, improved systems and methods are presented that utilize a ratio control concept with the vehicle output torque demand and predicted vehicle output torque to determine engine acceleration. This ratio control technique provides linear vehicle output torque delivery whilst delivering engine actuator acceleration. In one embodiment, a two-step approach is utilized. First, several conditions are evaluated to determine the constraining factor for speed control (i.e., a maximum possible acceleration limit). Second, a proportional ratio controller is employed and functions based on the requested output torque, the predicted output torque, and a maximum predicted output torque. Thereafter, a desired engine acceleration ratio is established and then processed through a history filter (e.g., a recursive root-mean-square (RMS) moving average filter) to mitigate any immediate changes in direction. Finally, the desired engine acceleration is adjusted accordingly with the maximum permissible acceleration limit. The primary potential benefit of these techniques is improved drivability.

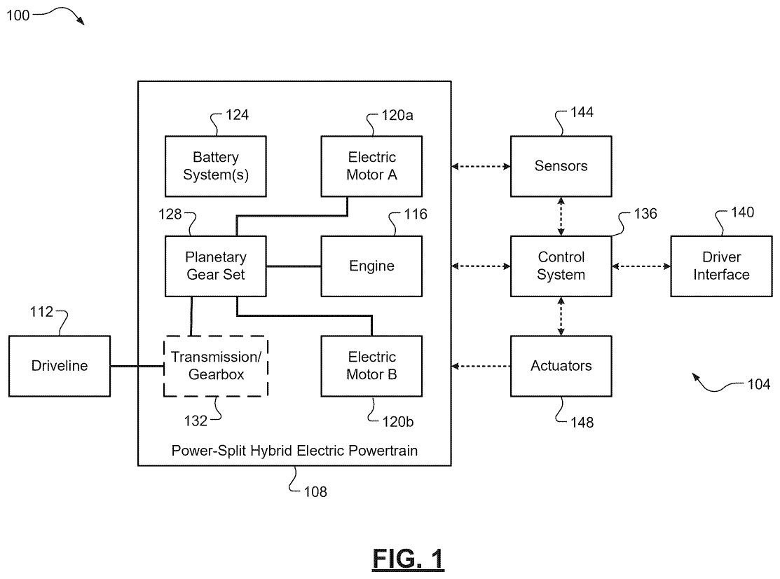

Referring now to FIG. 1, a functional block diagram depicting an electrified vehicle 100 having an example power-split hybrid electric powertrain 108 and a control system 104 according to the principles of the present application is illustrated. The power-split hybrid electric powertrain 108 (also “powertrain 108” for simplicity) generates and transfers drive torque to a driveline 112 for propulsion. The powertrain 108 includes an internal combustion engine 116 and first and second electric motors 120a, 120b (collectively, “electric motors 120”) that are powered by one or more high voltage battery systems 124. The engine 116 and the electric motors 120 are all connected to a planetary gear set 128. In one example configuration, the engine 116 is connected to a carrier of a planetary gear set 128, the first electric motor 120a is connected to a sun gear of the planetary gear set 128, and the second electric motor 120b is connected to a drive pinion of the planetary gear set.

In this configuration, a ring gear of the planetary gear set 128 and a counter-driven gear of the planetary gear set 128 are connected to deliver output power and vehicle acceleration, with the engine speed being controlled by the first electric motor 120a. The output torque from the planetary gear set 128 could be directly provided to the driveline 112 (e.g., in a hybrid transmission configuration) or a transmission or gearbox (e.g., a gear reducer) 132 could be provided to transfer the drive torque to the driveline 112. The transmission 132, for example, could comprise one or more clutches. A control system 136 controls operation of the electrified vehicle 100, including primarily controlling the powertrain 108 to generate a desired amount of drive torque to satisfy a driver torque request received from a driver via a driver interface 140 (e.g., an accelerator pedal). Sensors 144 monitor/measure various operating parameters of the powertrain 108 (shaft speeds/accelerations, torques, pressures, temperatures, etc.) and actuators 148 control the various components of the powertrain 108 (e.g., actuators for controlling the engine's air/fuel/spark). The control system 136 is also configured to perform the control techniques of the present application.

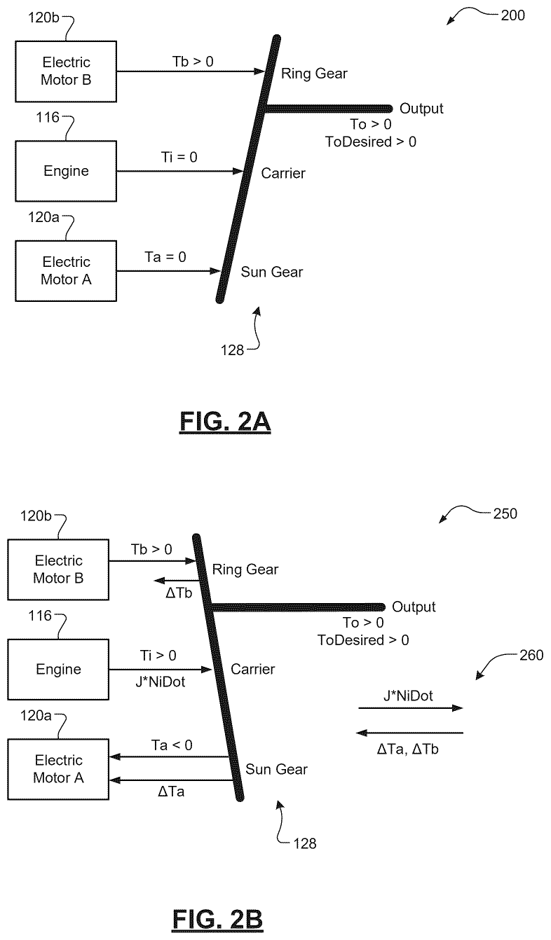

Referring now to FIGS. 2A-2B and with continued reference to FIG. 1, lever system diagrams 200, 250 depicting an example power-split hybrid electric powertrain (e.g., powertrain 108) during hybrid and electric driving modes according to the principles of the present application are illustrated. As shown, the engine 116 is connected to the carrier of the planetary gear set 128, the first electric motor 120a is connected to the sun gear of the planetary gear set 128, and the second electric motor 120b is connected to the drive pinion. The ring gear of the planetary gear set 128 and a counter-driven gear are connected to deliver output power. Due to the nature of the configuration of the powertrain 108, there is a nonlinear relationship between output torque and engine acceleration, where during hybrid driving (FIG. 2B), the system cannot fully or completely produce output torque and engine acceleration in phase due to the balancing of the lever to not lose engine speed control of the powertrain 108. At very high output power demand, the system could lose control of engine actuator acceleration in favor of delivering output power demand, this is also a case when the system is electrically discharge constrained.

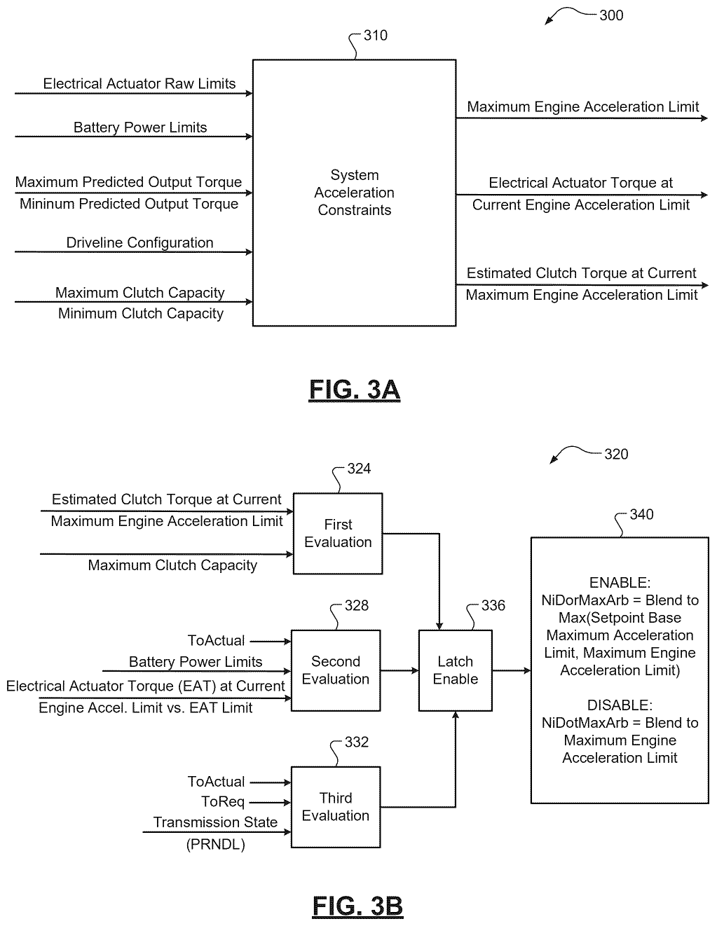

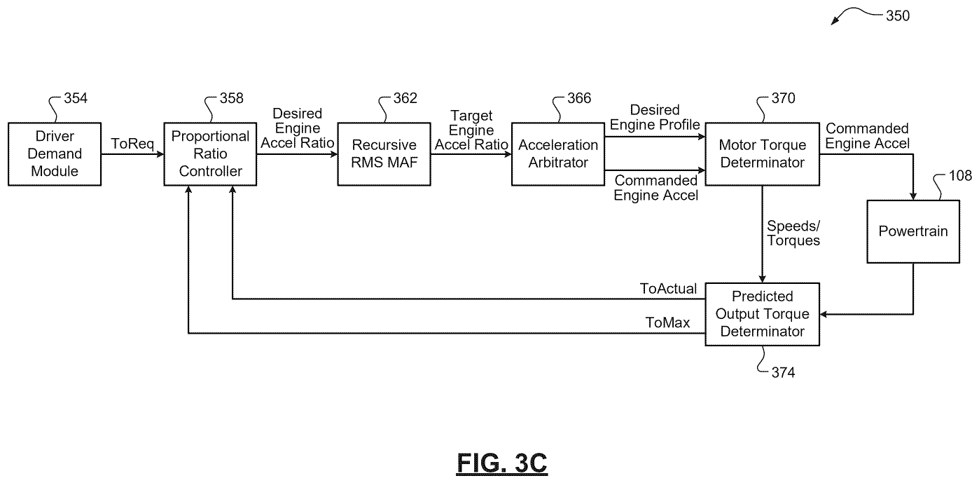

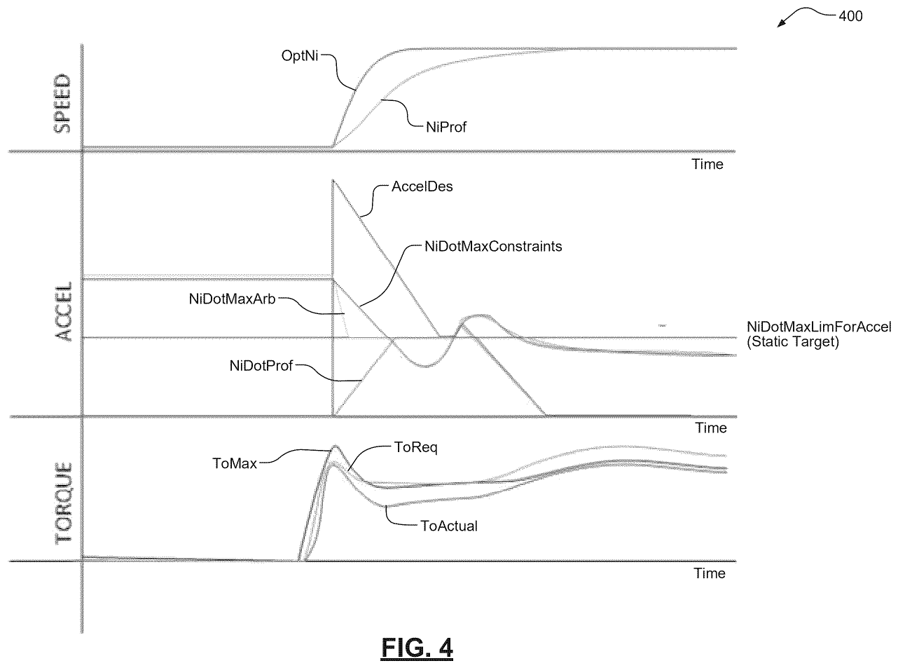

Referring now to FIGS. 3A-3C, functional block diagrams of example system architectures 300, 320, and 350 for a control system for a power-split hybrid electric powertrain (e.g., control system 104 for powertrain 108) according to the principles of the present application are illustrated. In FIG. 3A, block 310 determines system acceleration constraints. Inputs include electrical actuator raw limits, battery power limits, minimum/maximum predicted output torque, driveline configuration, and minimum/maximum clutch capacity and outputs include a maximum engine acceleration limit, an electrical actuator torque at current engine acceleration limit, and an estimated clutch torque at current maximum engine acceleration limit. In FIG. 3B, three different evaluations 324, 328, and 332 are performed and, when each is true, an enable latch 336 enables block 340. The first evaluation 324 evaluates if the primary electrical actuator is available for speed control, by comparing the primary electrical actuator torque at the current maximum acceleration limit against the raw actuator limits. The second evaluation 328 evaluates, based on the transmission (e.g., PRNDL) state or position, that output power is not compromised against a sign change, because when compensating for actuator acceleration, vehicle acceleration could be severely compromised.

The third evaluation 332 evaluates powertrain hardware element limits like calculated clutch torque needed at maximum engine acceleration against the raw clutch capacities to verify that, if the algorithm were to violate currently calculated engine acceleration limits, the clutch limits wouldn't be violated as a result, which could affect clutch energy and lead to heat dissipation concerns for the different components. When each evaluation is true, the enable latch 336 enables block 340. When enabled, the system limit of actuator acceleration are raised to a base set point maximum in the case of acceleration. When not enabled or disabled, the maximum engine acceleration limit is not increased. This process of FIGS. 3A-3B represents a first step or phase of the control techniques of the present application. In a subsequent second step or phase, a proportional ratio controller is employed, which functions based on the requested output torque, the predicted output torque, and the maximum predicted output torque. Subsequently, a desired engine acceleration ratio is established. This ratio is then processed through a history filter, specifically a recursive root mean square moving filter, to mitigate any immediate changes in direction. Following this, the desired engine acceleration is adjusted in accordance with the maximum permissible system acceleration limit (NiDotMaxArb) determined in the first step.

In FIG. 3C, an example system architecture 350 for the entire control process described above is illustrated. A driver demand module 354 determines an output torque request (ToReq) and provides it to a proportional ratio controller 358, which, based further on feedback of the actual output torque (ToActual) and the maximum output torque (ToMax). The proportional ratio controller 358 determines a desired engine acceleration (accel) ratio, which is provided to a history filter 362, which could be a recursive RMS moving average filter (MAF). The output of filter 362 is a target engine acceleration ratio, which is provided to an accelerator arbitrator 366. The arbitrator 366 determines a desired engine speed profile (NiProf) and a commanded engine acceleration, which are provided to a motor torque determinator 370. Based on these values, the motor torque determinator 370 generates motor torque commands (e.g., for the electric motors 120 of powertrain 108) and the speeds/torques are fed to a predicted output torque determinator 374, which determines the actual and maximum output torques ToActual, ToMax.

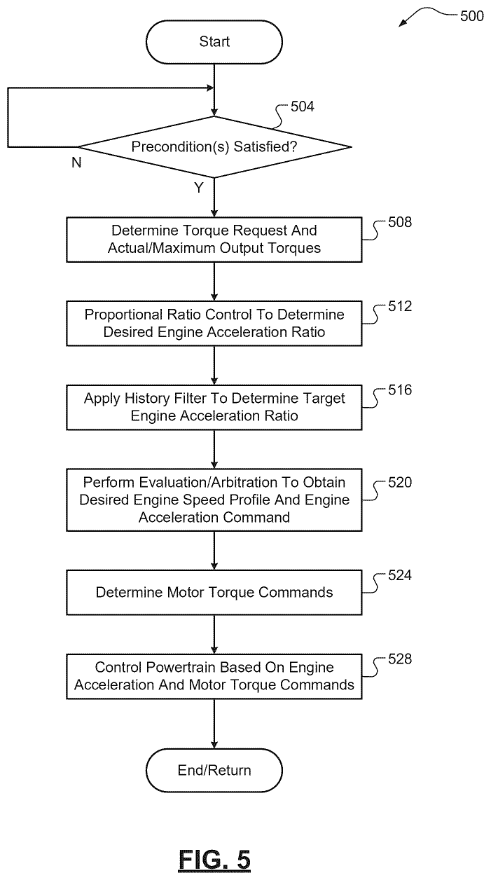

Referring now to FIG. 4 and with continued reference to the previous figures, a plot 400 depicting an example ratio control process for engine acceleration versus vehicle output torque according to the principles of the present application is illustrated. This use case pertains to a powertrain control system where the driver's demand for increased output power (ToReq) leads to a corresponding increase in the desired engine speed (OptNi). As the actual output torque (ToActual) rises, the engine's maximum acceleration begins to decrease to meet the torque demand while maintaining balance. To manage this, the system's maximum acceleration is max limited at a predetermined limit (NiDotMaxLimForAccel) from the first step. The engine's acceleration is then finely adjusted using a proportional ratio controller (from the second step) that considers the requested output torque, the actual output torque, and the maximum output torque limits. This feedback loop helps determine the optimal engine acceleration ratio, which in turn dictates the acceleration command for the electrical actuator (Ta). This command is crucial for achieving the desired engine speed profile (NiProf) while also minimizing the phase difference and drop in predicted output torque, ensuring the vehicle's drivability is within acceptable metrics.

Referring now to FIG. 5 and with continued reference to the previous figures, a flow diagram of an example ratio control method 500 for an electrified vehicle having a power-split hybrid electric powertrain according to the principles of the present application is illustrated. While the method 500 specifically references the control system 104 and the powertrain 108 and their various sub-components, it will be appreciated that this method 500 could be applicable to any suitably configured power-split hybrid electric powertrain/vehicle. The method 500 begins at 504 where an optional determination is made whether one or more preconditions are satisfied. These preconditions could include, for example, the powertrain 108 being powered up and running and there being no malfunctions present that would negatively impact or otherwise inhibit the control techniques of the present application. When false, the method 500 ends or returns to 504. When true, the method 500 proceeds to 508.

At 512, the control system 136 determines the torque request ToReq and the actual and maximum output torques ToActual, ToMax. At 512, the control system 136 performs proportional ratio control to determine a desired engine acceleration ratio. At 516, the control system 136 applies a history filter (e.g., a recursive RMS MAF) to determine a target engine acceleration ratio. At 520, the control system 136 performs a set of evaluations and selectively arbitrates to obtain a desired engine speed profile and an engine acceleration command. At 524, the control system 136 determines motor torque commands. Finally, at 528, the control system 136 controls the powertrain 108 based on the engine acceleration command and the motor torque commands. The method 500 then ends or returns to 504 or 508. It will be appreciated that each of these steps 508-528 could include multiple sub-steps as previously discussed herein and as shown in the figures (e.g., FIGS. 3A-3C).

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for power-split hybrid electric powertrain of an electrified vehicle, the control system comprising:
a set of actuators configured to control an engine of the powertrain and first and second electric motors of the powertrain, wherein the engine and the first and second electric motors are all connected to a planetary gear set; and
a control system configured to:
determine an output torque request for the powertrain and a previous actual output torque and maximum output torque of the powertrain;
perform proportional ratio control based on the output torque request, the actual output torque, and the maximum output torque of the powertrain to determine a desired engine acceleration ratio;
apply a history filter to the desired engine acceleration ratio to obtain a target engine acceleration ratio;
evaluate a set of conditions and selectively arbitrate between the target engine acceleration ratio and a maximum engine acceleration ratio based on the evaluation to determine a desired engine speed profile and an engine acceleration command;
determine motor torque commands based on the desired engine speed profile and the engine acceleration command; and
control the first and second electric motors based on the motor torque commands and the engine based on the engine acceleration command.

2. The control system of claim 1, wherein the engine is connected to a carrier of the planetary gear set, the first electric motor is connected to a sun gear of the planetary gear set, and the second electric motor is connected to a drive pinion of the planetary gear set, and a ring gear of the planetary gear set and a counter-driven gear are connected to deliver output power of the powertrain.

3. The control system of claim 2, wherein the set of evaluations comprises a first evaluation that evaluates if the first electric motor is available for speed control by comparing the first electric motor's torque at the current maximum acceleration limit against raw actuator limits.

4. The control system of claim 3, wherein the set of evaluations comprises a second evaluation that evaluates based on a transmission state or position, that output power is not compromised against a sign change.

5. The control system of claim 4, wherein the set of evaluations comprises a third evaluation that evaluates hardware element limits of the powertrain to verify that, if the current engine acceleration limit was violated, hardware elements of the powertrain would not be damaged.

6. The control system of claim 5, wherein the hardware element limits include a calculated clutch torque needed at a maximum engine acceleration against raw clutch capacities.

7. The control system of claim 5, wherein the control system is configured to increase the maximum engine acceleration limit when all three evaluations are true or satisfied.

8. The control system of claim 1, wherein the history filter is a recursive root-mean-square (RMS) moving average filter.

9. A control method for power-split hybrid electric powertrain of an electrified vehicle, the control method comprising:
controlling, by a set of actuators, an engine of the powertrain and first and second electric motors of the powertrain, wherein the engine and the first and second electric motors are all connected to a planetary gear set;
determining, by a control system, an output torque request for the powertrain and a previous actual output torque and maximum output torque of the powertrain;
performing, by the control system, proportional ratio control based on the output torque request, the actual output torque, and the maximum output torque of the powertrain to determine a desired engine acceleration ratio;
applying, by the control system, a history filter to the desired engine acceleration ratio to obtain a target engine acceleration ratio;
evaluating, by the control system, a set of conditions and selectively arbitrating, by the control system, between the target engine acceleration ratio and a maximum engine acceleration ratio based on the evaluation to determine a desired engine speed profile and an engine acceleration command;
determining, by the control system, motor torque commands based on the desired engine speed profile and the engine acceleration command; and
controlling, by the control system, the first and second electric motors based on the motor torque commands and the engine based on the engine acceleration command.

10. The control method of claim 9, wherein the engine is connected to a carrier of the planetary gear set, the first electric motor is connected to a sun gear of the planetary gear set, and the second electric motor is connected to a drive pinion of the planetary gear set, and a ring gear of the planetary gear set and a counter-driven gear are connected to deliver output power of the powertrain.

11. The control method of claim 10, wherein the set of evaluations comprises a first evaluation that evaluates if the first electric motor is available for speed control by comparing the first electric motor's torque at the current maximum acceleration limit against raw actuator limits.

12. The control method of claim 11, wherein the set of evaluations comprises a second evaluation that evaluates based on a transmission state or position, that output power is not compromised against a sign change.

13. The control method of claim 12, wherein the set of evaluations comprises a third evaluation that evaluates hardware element limits of the powertrain to verify that, if the current engine acceleration limit was violated, hardware elements of the powertrain would not be damaged.

14. The control method of claim 13, wherein the hardware element limits include a calculated clutch torque needed at a maximum engine acceleration against raw clutch capacities.

15. The control method of claim 13, wherein the control system is configured to increase the maximum engine acceleration limit when all three evaluations are true or satisfied.

16. The control method of claim 9, wherein the history filter is a recursive root-mean-square (RMS) moving average filter.
